(19) United States
(12) Patent Application Publication
(10) Pub. No.: US 2006/0047364 A1
(43) Pub. Date: Mar. 2, 2006

(54) Self-propelled cleaner

(75) Inventor: Takao Tani, Osaka (JP)

Correspondence Address: YOKOI & CO. U.S.A., INC., 13700 MARINA POINTE DRIVE #723, MARINA DEL RAY, CA, 90292, US

(73) Assignee: Funai Electric Co., Ltd., Osaka (JP)

(21) Appl. No.: 11/198,492

(22) Filed: Aug. 5, 2005

(30) Foreign Application Priority Data
Aug. 5, 2004 (JP) JP2004-229020

(51) Int. Cl. G06F 19/00

(52) U.S. Cl. 700/245; 701/23; 701/24

(57) ABSTRACT

Electronic components with which a monitoring unit is provided are an infrared CCD sensor and an output connector only, so that the monitoring unit is simple in construction. That is, the monitoring unit is designed such that it is not provided with a substrate or electronic component having complex wirings and contacts, whenever possible. Therefore, even if excessive force is applied to the monitoring unit upon mounting of the monitoring unit, it is possible to prevent producing of disorders of the monitoring unit. Furthermore, even if dirt or dust enters the recessed portion B1, possibilities that the dirt or dust will produce electrical short and disorders of the monitoring unit will occur can be reduced. An infrared CCD sensor is not provided at a body BD unless the user attach the monitoring unit to the body BD, so that the cost of the body BD itself can be decreased.

### BACKGROUND OF THE INVENTION

1. Field of the Invention

The present invention relates to a self-propelled cleaner that comprises a body provided with a cleaner mechanism, and a driving mechanism for realizing steering and driving.

2. Description of the Prior Art

Hitherto, as this type of self-propelled cleaner, there has been proposed a self-propelled cleaner in which defense information is obtained by cameras or the like (see, for example, the paragraph 0089 of Japanese Patent Application Laid-Open No. 2000-342496).

With such a construction, the self-propelled cleaner can travel over a wide range inside the house, so that the self-propelled cleaner can monitor suspicious persons over the wide range.

However, in the conventional self-propelled cleaner described above, there was a problem that production cost rose by the cameras or the like for monitoring suspicious persons, which were incorporated. In particular, unnecessary cost was charged up against users who did not intend to monitor suspicious persons. In respect of this, a set of means required for monitoring suspicious persons is supplied as a separate optional unit, whereby a production cost is reduced and the unnecessary burden on the users can be prevented. However, since the self-propelled cleaner is used in an environment in which much dirt and/or dust exists, if a substrate having electronic parts mounted thereon is attached to the exterior of the cleaner body as an optional unit, there is a problem that any disorders are brought about by the dirt and/or dust or the like. Additionally, since a stratum of main users of self-propelled cleaners is often inexperienced in operating machines. Therefore, there was a problem that, upon installation and removal, the users might accidentally break the substrate and/or the like.

### SUMMARY OF THE INVENTION

The present invention has been made in view of the foregoing. It is an object of the present invention to provide a self-propelled cleaner in which production cost of a body is reduced and a monitoring unit additionally provided is difficult to be disordered.

In order to attain the above-mentioned object, in accordance with one aspect of the invention, there is provided a self-propelled cleaner comprising a body provided with a cleaner mechanism and a driving mechanism for realizing steering and driving, the body comprising a recessed portion to which a monitoring unit can be mounted, the monitoring unit comprising at least an infrared CCD sensor, an output connector that can output image signals obtained by said infrared CCD sensor, and a positioning plate of a substantially plate-shape, a positioning hole into which said positioning plate inserted, whereby the monitoring unit is positioned, an input connector electrically connected to the output connector through the recessed portion, an infrared ray-permeable lid portion for covering said monitoring unit mounted to the recessed portion, an image analyzing unit for analyzing the image signals inputted from the input connector, to thereby judge whether or not an image of a suspicious person is picked up by said infrared CCD sensor, a speaker, a wireless LAN, and a warning unit for alarming through the speaker when the image analyzing unit judges that the image of the suspicious person is picked up by the infrared CCD sensor, and transmitting alarm signals to other devices through the wireless LAN.

In this aspect constructed as described above, when the self-propelled cleaner performs cleaning with the cleaner mechanism provided at the body, the driving mechanism realizes steering and traveling. The body is formed with the recessed portion to which the monitoring unit can be mounted. The monitoring unit is comprised of at least the infrared CCD sensor, the connector capable of outputting the image signals obtained by the infrared CCD sensor, and the substantially plate-shaped positioning plate. When the monitoring unit is to be mounted to the recessed portion, the positioning plate is inserted into the positioning hole that is formed in the recessed portion, whereby the monitoring unit can be mounted to a precise position of the recessed portion.

Furthermore, when the monitoring unit is mounted to the recessed portion, electrical connection between the output connector and the input connector provided at the recessed portion is made, whereby the body can obtain the image signals obtained by the infrared CCD sensor. Also, the body is provided with the lid portion that can cover the monitoring unit mounted to the recessed portion. Incidentally, since the lid portion allows infrared rays to pass therethrough, the infrared CCD sensor can pick up the exterior situation through the lid portion.

Furthermore, the body is provided with the image analyzing unit that performs analysis of the image signals inputted from the input connector. The image analyzing unit judges whether or not an image of a suspicious person is picked up by the infrared CCD sensor. Furthermore, the body is provided with the warning unit that alarms when the image analyzing unit judges that the image of the suspicious person is picked up by the infrared CCD sensor. Concretely, the speaker that is provided at the body alarms and the wireless LAN that is provided at the body transmits alarm signals to other devices.

According to the above-mentioned construction, electronic parts that are provided at the monitoring unit are limited to the infrared CCD sensor and the output connector. Thus, a substrate or the like having electronic parts complexly mounted thereon is not provided on the outside of the body, so that any disorders of the substrate or the like will be hardly brought about by installation and removal of the substrate or by dirt and/or dust. Furthermore, by the provision of the lid portion, the monitoring unit can pickup an image of the exterior and can be protected.

By the way, the image analyzing unit and the warning unit are provided at the body and are not employed as additionally optional units. However, practically, the image analyzing unit and the warning unit can be realized on a CPU that is used for drive control of the self-propelled cleaner. In the CPU, a program that corresponds to the image analyzing unit and the warning unit may be performed. For example, by causing a program memorized in a ROM to correspond to the image analyzing unit and the warning unit, the image analyzing unit and the warning unit can be realized. That is, even if the image analyzing unit and the warning unit are provided at the self-propelled cleaner, the provision of the image analyzing unit and the warning unit does not mean an addition of an essential construction, so that production cost can be restrained so as not to be increased.

As the cleaner mechanism that is provided at the body, there may be employed a suction-type cleaner mechanism or a cleaner mechanism in which sweeping is performed utilizing brushes, or a combination thereof. Regarding the driving mechanism for performing steering and driving of the cleaner, it may be constructed so that driving wheels provided at the left and right sides of the body are separately rotation-controlled, whereby steering and driving of the cleaner that includes advance, rearward movement, left and right turn and rotation at the same place can be performed. Incidentally, this is not to say that supplementary wheels may be provided at the front and rear sides of the body. Furthermore, the driving mechanism is not limited to wheels. In lieu of wheels, endless belt that are driven may be employed. Besides the endless belts, the driving mechanism can be realized by various constructions, for example, four wheels or six wheels.

In accordance with another aspect of the invention, there is provided a self-propelled cleaner that comprises a body provided with a cleaner mechanism and a driving mechanism for realizing steering and driving, the body comprising a recessed portion to which a monitoring unit can be mounted, the monitoring unit comprising at least an image picking-up sensor, and an output connector that can output image signals obtained by the image picking-up sensor, an input connector electrically connected to the output connector through the recessed portion, an image analyzing unit for analyzing the image signals inputted from the input connector, to thereby judge whether or not an image of a suspicious person is picked up by the image picking-up sensor, and a warning unit for alarming when the image analyzing unit judges that the image of the suspicious person is picked up by the image picking-up sensor.

In this aspect constructed as described above, when the self-propelled cleaner performs cleaning with the cleaner mechanism provided at the body, the driving mechanism realizes steering and traveling. The body is formed with the recessed portion to which the monitoring unit can be mounted. The monitoring unit is comprised of at least the image picking-up sensor, and the connector capable of outputting the image signals obtained by the image picking-up sensor. When the monitoring unit is mounted to the recessed portion, electrical connection between the output connector and the input connector provided at the recessed portion is made, whereby the body can obtain the image signals obtained by the image picking-up sensor.

As described above, according to these aspects, a production cost of the body is reduced and there is provided the self-propelled cleaner in which disorders of the monitoring unit additionally mounted will hardly occur.

Furthermore, the body is provided with the image analyzing unit that performs analysis of the image signals inputted from the input connector. The image analyzing unit judges whether or not an image of a suspicious person is picked up by the image picking-up sensor. Furthermore, the body is provided with the warning unit that alarms when the image analyzing unit judges that the image of the suspicious person is picked up by the image picking-up sensor.

According to the above-mentioned construction, electronic parts that are provided at the monitoring unit are limited to the image picking-up sensor and the output connector. Thus, a substrate or the like having electronic parts complexly mounted thereon is not provided on the outside of the body, so that any disorders of the substrate or the like will be hardly brought about by installation and removal of the substrate or by dirt and/or dust.

Further, the monitoring unit may be provided with a positioning plate of a substantially plate-shape projecting therefrom, and the recessed portion may be formed with a positioning hole in which the positioning plate is inserted, whereby the monitoring unit is positioned.

In this construction, the positioning plate of a substantially plate-shape may be projected from the monitoring unit. On the other hand, the recessed portion may be formed with the positioning hole in which the positioning plate is inserted and which performs positioning of the monitoring unit. Thus, the monitoring unit can be mounted to a precise location of the recessed portion.

Furthermore, according to the construction, the monitoring unit can be precisely mounted.

Still further, the body may be adapted to allow a light having a wavelength zone that can be inputted by the image picking-up sensor, to pass through the body, and the body further may include a lid portion for covering the monitoring unit mounted to the recessed portion.

In this construction, the body may be provided with the lid portion that can cover the monitoring unit mounted to the recessed portion. The lid portion may be constructed so that it allows the light having a wavelength zone that can be inputted by the image picking-up sensor, to pass through the lid portion. For example, the entire lid portion or a part of the lid portion may be made of any material through which the light having a wavelength zone that can be inputted by the image picking-up sensor can pass. Furthermore, the lid portion may be provided with a window that allows incidence of light. Thus, the monitoring unit can pick up an image of the exterior and can be protected.

Also, according to the construction, the monitoring unit can be protected from dirt and/or dust or any shock.

Yet further, the image picking-up unit may comprise an infrared CCD sensor.

In this construction, as the image picking-up sensor, the infrared CCD sensor may be employed. The infrared CCD sensor can reproduce the good quality of an image and is effective for detection of the human body.

Also, according to the construction, it is possible to precisely judge a suspicious person.

Further, the body may be provided with a speaker and the warning unit is adapted to alarm through the speaker.

In this construction, by using the speaker provided at the body, it is possible to inform a user of abnormal occurrences using voice.

Furthermore, it is possible to produce alarms.

Still further, the body may be provided with a wireless LAN and the warning unit may be adapted to transmit alarm signals to other devices through the wireless LAN.

In this construction, it is preferable that when alarms are produced, the wireless LAN provided at the body sends the alarm signals to other devices, whereby alarm signals can be sent to a user who is present at a place remote from the cleaner. For example, as other devices, it is possible to send alarm signals to a portable terminal such as a potable telephone.

Furthermore, according to the construction, it is possible to produce alarms using an external equipment.

The object, other objects and many of the attendant advantages of the present invention will be readily appreciated as the same becomes better understood by reference to the following detailed description when considered in connection with the accompanying drawings, in which like reference designators denote like or corresponding parts throughout, wherein:

### BRIEF DESCRIPTION OF THE DRAWINGS

FIG. 1 is a block diagram illustrating a schematic construction of a self-propelled cleaner according to the present invention;

FIG. 2 is a detailed block diagram of the self-propelled cleaner;

FIG. 3 is a block diagram of AF proximity sensors;

FIG. 4 is a view that is of assistance in explaining the state of a floor surface and the state of change in a measurement distance in the event that the AF proximity sensors are oriented obliquely and downward relative to the floor surface;

FIG. 5 is a view that is of assistance in explaining a measurement distance of an image picking-up range in the event that the AF proximity sensors for detecting a facing position are oriented obliquely and downward relative to the floor surface;

FIG. 6 is a view that shows arranging positions of and distance measuring portions of the respective AF proximity sensors;

FIG. 7 is a perspective view of a body;

FIG. 8 is a perspective view of a monitor unit;

FIG. 9 is a view illustrating an appearance of a marker;

FIG. 10 is a flowchart of travel control;

FIG. 11 is a flowchart of cleaning and traveling;

FIG. 12 is a view illustrating a travel route in a room;

FIG. 13 is a flowchart of a mapping process;

FIG. 14 is a view that is of assistance in explaining the mapping process;

FIG. 15 is a view that is of assistance in explaining a process for communicating map-information in respective rooms after mapping;

FIG. 16 is a view showing a setting screen of monitor time and monitoring region;

FIG. 17 is a flowchart of a monitoring process; and

FIG. 18 is a flowchart of a process for confirming suspicious persons.

### DESCRIPTION OF THE PREFERRED EMBODIMENTS

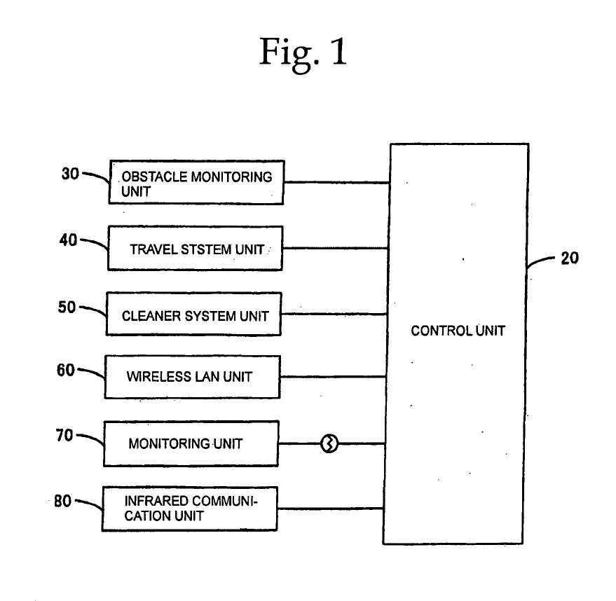

FIG. 1 shows a schematic construction of a self-propelled cleaner device of an embodiment of the present invention with a block diagram.

As shown in the same Figure, the self-propelled cleaner device comprises a control unit 20 for controlling respective units, an obstacle monitoring unit 30 for detecting environmental obstacles, a travel system unit 40 for realizing movement, a cleaner system unit 50 for carrying out cleaning, a wireless LAN unit 60 for connection to a LAN by radio, a monitoring unit 70 that can be additionally mounted, and an infrared communication unit 80 that can communicate utilizing a marker and infrared rays which will be discussed hereinafter. Incidentally, a body BD of the cleaner device is formed into a thin and substantially cylindrical shape.

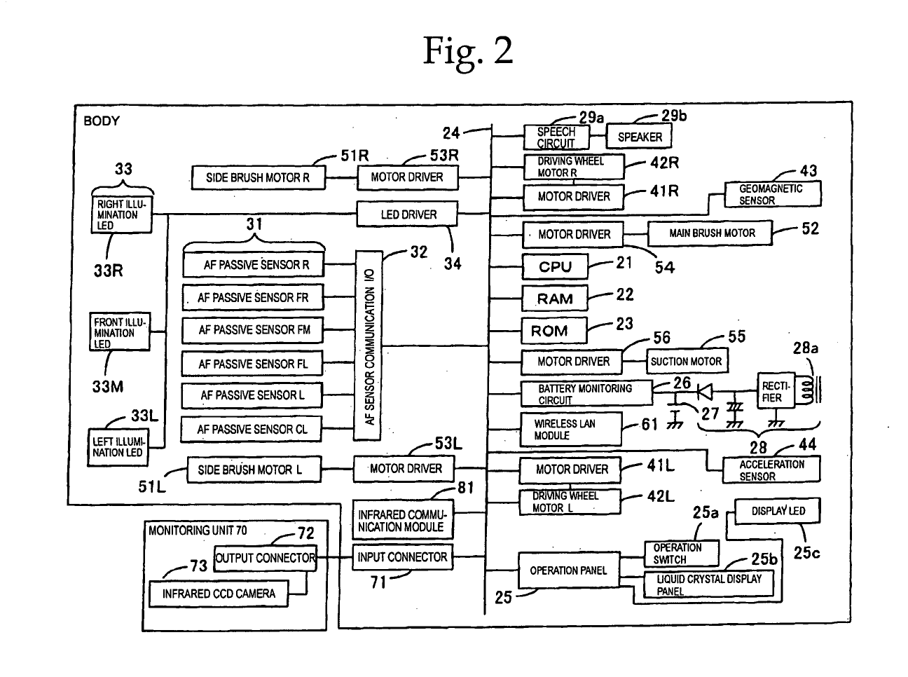

FIG. 2 shows a construction of an electric system for concretely realizing the respective units, with a block diagram.

A CPU 21, a ROM 23 and a RAM 22 are connected through a bus 24 to the body BD as the control unit 20. The CPU 21 performs various controls using the RAM 22 as a work area according to a control program memorized in the ROM 23, and various parameter tables. The contents of the above-mentioned control program will be discussed hereinafter.

The bus 24 is provided with an operation panel unit 25. The operation panel unit 25 is provided with various operation switches 25a, a liquid crystal display panel and a display LED 25c. While the liquid crystal display panel comprises a monochrome liquid crystal display panel that can display in a multi-gradation manner, it may comprise a color liquid crystal display panel or the like.

The body BD has a battery 27. The CPU 21 is constructed so as to be capable of monitoring a residual quantity of the battery 27 through a battery monitoring circuit 26. Incidentally, the battery 27 is provided with a charging circuit 28 that carries out charging using electrical power that is supplied in a noncontacting manner. The battery monitoring circuit 26 mainly monitors the voltage of the battery 27 and detects the residual quantity. Also, the body BD includes a speech circuit 29a that connects the bus 24. A speaker generates voice according to speech signals that are produced in the speech circuit 29a.

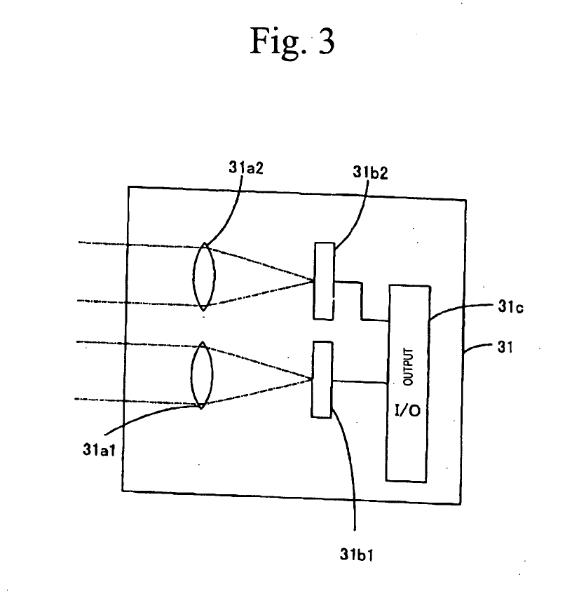

The obstacle monitoring unit 30 comprises AF proximity sensors 31 (31R, 31FR, 31FM, 31FL, 31L, 31CL) acting AF distance-measuring sensors for auto focus (hereinafter referred to as “AF”), an AF sensor communication I/O32 acting as a communication interface for the proximity sensors, an illumination LED 33, and a LED driver 34 that supplies driving current to respective LEDs. As the AF proximity sensors 31 (31R, 31FR, 31FM, 31FL, 31L, 31CL), there may be employed passive sensors or ultrasonic sensors. First of all, the construction of the AF proximity sensors 31 will be discussed hereinafter. FIG. 3 shows a schematic construction of the AF proximity sensor 31. The AF proximity sensor 31 comprises biaxial optical systems 31a1, 31a2 having parallel optical axes, CCD line sensors 31b1, 31b2 generally arranged at locations where image formations are made by the optical systems 31a1, 31a2, and an output I/O31c for outputting image data, that are picked up by the respective CCD line sensors 31b1, 31b2, to the external.

The CCD line sensors 31b1, 31b2 are comprised of image picture elements of 160-170 elemental areas that convert light energy into electrical energy, in which electrical energy generated for each image picture element can be stored as charge. Eight bit data can be outputted according to the quantity of charge stored at the respective image picture elements. The quantity of charge that is stored at determined time corresponds to light energy inputted. Charge of a different value is stored in each of the image picture elements, depending upon amount of and wavelength of inputted light. That is, the CCD line sensors 31b1, 31b2 are adapted to be able to produce data that can be indicative of inputted images.

The optical systems are biaxial, so that gaps corresponding to distances are produced in formed images. It is possible to measure the distances based on the gaps of data outputted from the respective CCD line sensors 31b1, 31b2. For example, the shorter the distance, the greater the gap of the formed image, and the greater the distance, the less the gap of the formed image. Therefore, a data array for every 4-5 picture elements in one output data is scanned in the other output data, the difference in the address of an original data array and the address of a found data array is determined, different amount-distance conversion table that is previously stored in the ROM 23 is referred with the different amount, and an actual distance is found.

Of the AF proximity sensors 31R, 31FR, 31FM, 31FL, 31L and 31CL, the AF proximity sensors 31FR, 31FM and 31FL are used for detecting front obstacles and the AF proximity sensors 31R and 31L are used for detecting ahead, left and right, and right-front obstacles, and the AF proximity sensor 31CL is used for detecting distances to the front and a ceiling.

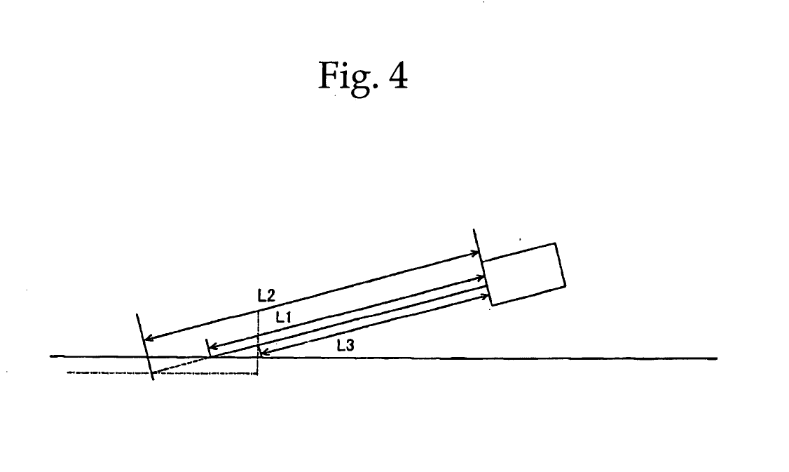

FIG. 4 illustrates the principle on detecting the front, ahead, left and right obstacles by the AF proximity sensors 31. These AF proximity sensors 31 are arranged so as to be obliquely directed toward an environmental floor. Where any obstacles do not exist ahead, a measurement distance that is to be detected by the AF proximity sensors 31 is L1 in a substantially whole imaging range. However, where there is a step as indicated in FIG. 4 by a chain line, a measurement distance is L2. Where a measurement distance is elongated, it is judged that there is a descending step. Also, where there is an ascending step as indicated in FIG. 4 by a chain double-dashed line, a measurement distance is L3. Where there is an obstacle, a measurement distance is measured as a distance to the obstacle in the same manner in which a measurement distance is measured as a distance to the ascending step in the case where there is the ascending step, and becomes shorter than the floor surface.

In this embodiment, in a case where the AF proximity sensors 31 were obliquely directed toward a forward portion of the floor surface, the imaging range grew to about 10 cm. Since the width of the self-propelled cleaner according to the present invention was 30 cm, the three AF proximity sensors 31FR, 31FM, 31FL are arranged with angles thereof being slightly changed in such a manner that the imaging ranges thereof are not superposed. Thus, the three AF proximity sensors 31FR, 31FM, 31FL can detect an obstacle and/or a step within the forward range of 30 cm. Of course, a detect width is changed according to the specification of the sensors and the mounting positions thereof. Numbers of the sensors may be employed according to a detection width that is actually required to be detected.

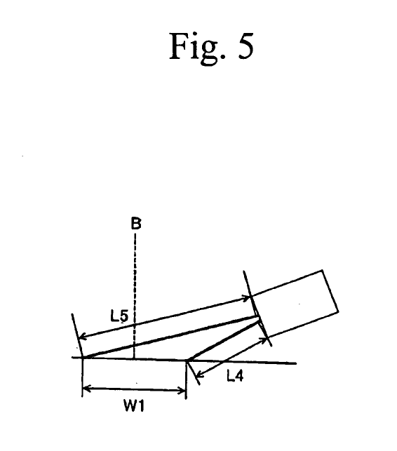

On the other hand, the AF proximity sensors 31R, 31L for detecting the ahead, left and right, and right-front obstacles are arranged obliquely relative to the floor surface with an imaging range thereof being set on the basis of a vertical direction. Also, the AF proximity sensor 31R is attached to the left side of the body and is opposed so as to image a range that extends across a center of the body from a location just before the right to the right over the width of the body. The AF proximity sensor 31L is attached to the right side of the body and is opposed so as to image a range that extends across the center of the body from a location just the left to the left over the width of the body.

Where the AF proximity sensors 31R, 31L are not crossed are adapted to image a position just before the left and right, the sensors must be opposed to the floor surface at an acute angle relative to the floor surface. This causes the image range to be narrowed and, therefore, requires a plurality of sensors. Therefore, the AF proximity sensors 31R, 31L are arranged so as to be positively crossed, whereby the image range is broadened and the necessary range can be detected with a small number of sensors. Also, to causes the image range to be obliquely arranged on the basis of the vertical direction means that an array of the CCD line sensors is directed to the vertical direction. As shown in FIG. 5, a width that can be to be imaged is W1. In the example, a distance L4 to the floor surface at a right side of the image range is short and a distance L5 at a left side is long. Where a boundary line of a side surface of the body BD is located at a chain line position B indicated in FIG. 5, an image range to the boundary line is used for detecting steps or the like, and an image range beyond the boundary line is used for detecting whether or not there is a wall surface.

The AF proximity sensor 31CL for detecting a distance to a forward ceiling is opposed to the ceiling. Generally, a distance from the floor surface to the ceiling that is detected by the AF proximity sensor 31CL is constant, but as the AF proximity sensor 31CL approaches the wall surface, an image range is not the ceiling but is the wall surface, so that a distance to be measured is shortened. Therefore, the existence of the forward wall surface can be preciously detected.

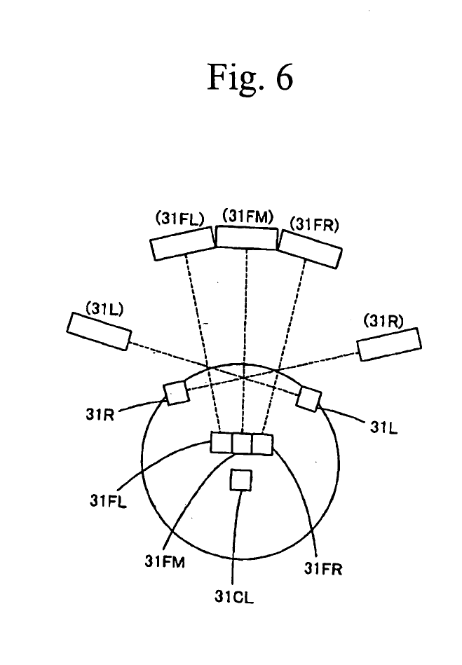

FIG. 6 shows mounting positions of the respective AF proximity sensors 31R, 31FR, 31FM, 31FL, 31L, 31CL that are attached to the body BD, and image ranges of the respective AF proximity sensors relative to the floor surface that are correspondingly indicated by designators parenthesized. Incidentally, the image range relative to the ceiling is omitted. In order that the images obtained by the AF proximity sensors 31R, 31FR, 31FM, 31FL, 31L can be proved, there are provided a right illumination LED 33R, a left illumination LED 33L and a front illumination LED 33M that are comprised of white LEDs. A LED driver 34 is adapted to supply drive current according to control instructions from CPU 11 and lights. Thus, even if the cleaner is driven at night and a dark area under a table or the like is cleaned by the cleaner, it is possible to obtain effective pick-up images from the AF proximity sensors 31.

The travel system unit 40 comprises motor drivers 41R, 41L, driving wheel motors 42R, 42L, and unshown gear units and driving wheel that are driven by the driving wheel motors 42R, 42L. The driving wheels are arranged at the left and right sides of the body BD one by one. In addition, a free driving wheel that is not provided with a driving source is provided at a lower region of a central of the front of the body. The driving wheel motors 42R, 42L can be fully driven by the motor drivers 41R, 41L in the terms of rotation direction and rotation angle. The respective motor drivers 41R, 41L outputs drive signals according to the control instructions from the CPU 11.

It is possible to precisely detect actual rotation direction and rotation angle from an output of a rotary encoder integrally attached to the driving wheel motors 42R, 42L. Incidentally, the rotary encoder may not be attached directly to the driving wheels, a freely rotatable driven wheel is provided in proximity to the driving wheels, and rotation amount of the driven wheel is fed back, whereby even if slip of the driving wheels occurs, actual rotation amount can be detected. The travel system unit 40 further includes a geomagnetic sensor 43. It is possible to judge a travel direction by checking up with a geomagnetism. Also, an acceleration sensor 44 detects accelerations in three XYZ-axial directions, and outputs detected results. As the gear units and the driving wheels, there may be employed various gear units and driving wheels. Traveling may be effected by driving Circular rubber wheels and endless belts.

The cleaning mechanism of the self-propelled cleaner device comprises side brushes arranged at both sides of the front of the body and for scraping up dirt and/or dust that exists at both sides of the body in a travel direction, in the vicinity of the central of the body BD, a main brush for scooping up the dirt and/or dust scraped up in the neighborhood of the central of the body, and a suction fan for sucking the dirt and/or dust scooped up by the main brush and accommodating the dirt and/or dust in a dust box. The cleaner system unit 50 comprises side brush motors 51R, 51L and a main brush motor 52 for driving the respective brushes, motor drivers 53R, 53L, 54 for supplying driving power to the respective motors, a suction motor 55 for driving the suction fan, and a motor driver 56 for supplying driving power to the suction motor. Cleaning that is performed using the side brushes and the main brush is suitably judged and controlled by the CPU 11 according to the condition of the floor surface, the condition of the battery, instructions from the user, and the like.

The wireless LAN unit 60 comprises a wireless LAN module 61. The CPU 21 can be connected to an external LAN by radio according to a predetermined protocol. On the condition that there are unshown access points, the wireless LAN module 61 shall be governed by an environment in which the access points can be connected to a wideband net work (for example, an internet) through routers or the like. Therefore, it is possible to carry out transmit-receive of usual mail through the internet and reading of web site. Incidentally, the wireless LAN module 61 is comprises of a standardized card slot, a standardized wireless-LAN card, which is connected to the slot, and the like. Of course, a different standardized card can be connected to the card slot.

The monitoring unit 70 is an optical unit that is additionally attached to the body BD. As shown in FIG. 2, the monitoring unit 70 is comprised of an infrared CCD sensor 73, and an output connector 72 that can output to the external pick-up signals that are produced by imaging by means of the infrared CCD sensor 73. On the other hand, the body BD is provided with an input connector 71 that can receive the pick-up signals produced by the infrared CCD sensor 73. The pick-up signals which are obtained by the input connector are transmitted through the bus 24 to the CPU 21 in which the pick-up signals are then subjected to various processes.

The infrared CCD sensor 73 includes an optical system that can image the front, and produces electric signals according to infrared rays that are inputted from a sight that is realized by the optical system. Specifically, there are provided a plurality of photodiodes that are arranged correspondingly to the picture elements at image formation locations where are determined by the above-mentioned optical system. The respective photodiodes produce electric signals that correspond to electric energies of the inputted infrared-rays. A CCD element temporarily memorizes the electric signals that are produced for every picture elements. For the respective picture elements, the electric signals produce continued pick-up signals. The produced pick-up signals are suitably outputted to the output connector 72.

The infrared CCD sensor 73 performs imaging for a lot of time. The CPU 21 makes comparison of the pick-up signals that are obtained for a lot of time, whereby the light amount of the infrared rays or the like which vary for the lot of time can be recognized. That is, by recognizing change in the light amount of the infrared rays inputted by the infrared CCD sensor 73, or the like, the existence of the human body that is the variable of an infrared ray-emission amount can be recognized. For the pick-up signals that are produced by the infrared CCD sensor 73, the CPU 21 carries out predetermined processes, whereby the infrared CCD sensor 73 can be used as a human body sensor. Incidentally, the comparing processes of the pick-up signals obtained for the lot of time that are performed by the CPU 21 will be fully discussed hereinafter.

Incidentally, while in the illustrated example the infrared CCD sensor 73 constitutes the human body sensor utilizing change in the infrared rays incident in the infrared CCD sensor 73, the infrared CCD sensor is not limited to such a human body sensor. For example, the infrared CCD sensor may be constructed in such a manner that when the amount of the processing to be performed by the CPU 21 increases, the infrared CCD sensor 73 picks up color images, searches a color region corresponding to a skin-color that is characteristic of the human body, and senses the human body according to a size of the region and change in the region. Furthermore, when the amount of the processing by the CPU 21 is highly required, an image arithmetic and logic unit that is specially designed for performing an image processing of the image signals may be additionally provided, and a VRAM may be provided besides the RAM 22. Since the image signals can be inputted to the bus 24 of the body BD, the above-mentioned image arithmetic and logic unit and the above-mentioned VRAM may be provided at the body BD so as to be connected to the bus 24.

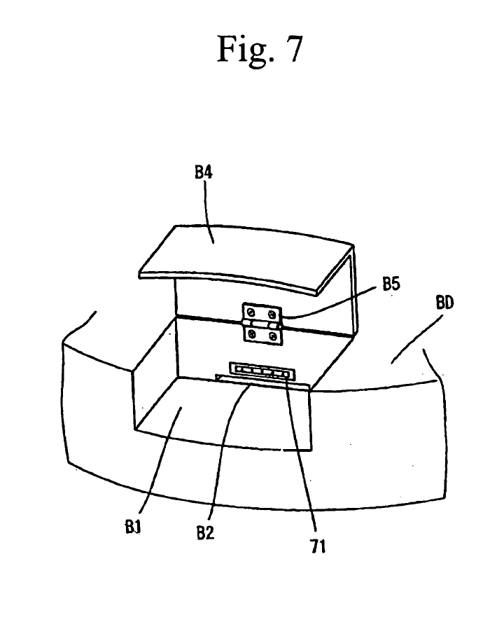

FIG. 7 illustrates the appearance of the body BD. Referring to the same Figure, the body BD is of a thin, substantially cylindrical shape, and formed with a recessed portion B1 that spreads from a top surface to a side surface in a portion of the body BD that corresponds to the front. That is, that recessed portion B1 is formed by causing an upper corner, in which the top surface and the side surface are tangent to each other in the front of the thin, substantially cylindrical shaped-body BD, to be notched. The recessed portion B1 comprises a bottom wall, an innermost wall, and both side walls, and opened at the top and front sides thereof. A line-shaped positioning hole B2 is formed in a lowermost region of the innermost wall of the recess portion B1 so as to be oriented horizontally. The interior of and the exterior of the body BD are communicated with each other through the positioning hole B2. The input connector 71 is formed in a region of the innermost wall that is above the positioning hole B2, and is also oriented horizontally. The input connector 71 is connected to the bus 24 in the interior of the body BD. A hinge B5 is provided at a topmost region of the innermost wall of the recessed portion B1. A lid portion B1 and the body BD are connected to each other by the hinge B5. The lid portion B4 is formed into a L-shape in cross-section so as to cover the top and front of the recessed portion B1 that are opened, and is pivotally connected to the body BD through the hinge B5. In the state shown in FIG. 7, the lid portion B4 is jumped up. Thus, the recessed portion B1 can be opened. On the other hand, the lid portion B4 is pivoted, whereby the recessed portion B1 can be closed from the outside. Thus, the recessed portion B1 can be protected from dirt and/or dust. Incidentally, the recess portion B1 is made of any synthetic resin through which light of various lengths including an infrared ray can pass.

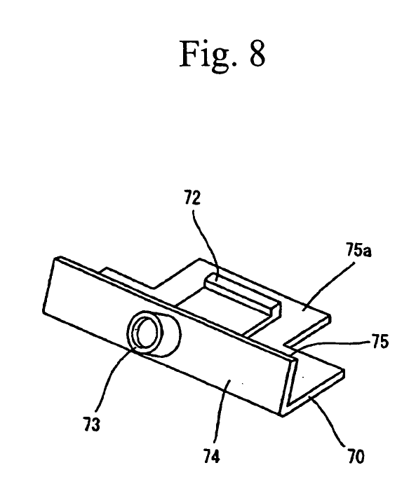

FIG. 8 illustrates a monitoring unit 70 as viewed from the oblique direction. Referring to the same Figure, the monitoring unit 70 is comprises of a substantially plate-shaped base surface 75 and a slant surface 74. The base surface 75 and the slant surface 74 cross at a predetermined angle. The infrared CCD sensor 73 is attached to a substantially central portion of the slant surface 74. By optimizing the tilt angle of the slant surface 74, the view angle of the infrared CCD sensor is optimized. Now, the term “optimizing” means that for example, the whole body of a suspicious person is taken in the whole view. For example, the term means that the whole body can be suitably taken in the whole view so as not to be taken at upper, lower, left and right locations that are offset. Furthermore, the base surface 75 is formed into a substantially plate-shape and has a positioning plate 75a having a slightly narrow width and projecting from the base surface 75 in a depth direction. The width of the positioning plate 75a is slightly narrower than that of the positioning hole B2. The size of the whole monitoring unit 70 is smaller than that of the recessed portion B1.

With the above-mentioned construction, the monitoring unit 70 can be mounted through the recessed portion B1 and housed within a spaced that is closed by the lid portion B4 and the recessed portion B1. Therefore, a disorder of the monitoring unit 70 which may occur by striking of the monitoring unit 70 against any object and adhering of dirt and/or dust to the monitoring unit 70 can be prevented. Since the lid portion B4 is made of any material through which infrared rays pass, the situation of the external can be imaged by the infrared CCD sensor 73. When the monitoring unit 70 is to be mounted through the recessed portion B1, the monitoring unit 70 can be mounted to a precise location by inserting the projecting positioning plate 75a into the positioning hole B2. By inserting the positioning plate 75a into the positioning hole B2 and then forcing the positioning plate 75a into the positioning hole B2 until the base surface 75 is abutted against the innermost wall of the recessed portion B1, the output connector 72 and the input connector 71 are adapted to be connected to each other. Therefore, connection between the body BD and the monitoring unit 70 can be positively performed.

Electronic parts that are provided at the monitoring unit 70 are the infrared CCD and the output connector 72 only, so that the monitoring unit 70 is simple in construction. That is, whenever possible, a substrate or an electronic component which has a complex wire structure and contact points is not provided at the monitoring unit 70. Therefore, even if any unnecessary force is applied to the monitoring unit 70 upon mounting of the monitoring unit 70, it is possible to prevent a disorder of the monitoring unit 70 from occurring. Furthermore, even if dirt and/or dust enters the interior of the recessed portion B1, it is possible to prevent electrical short from generating in an electrical circuit portion of the monitoring unit 70 due to the dirt and/or dust, and reduces a possibility that a disorder of the monitoring unit 70 will be brought about.

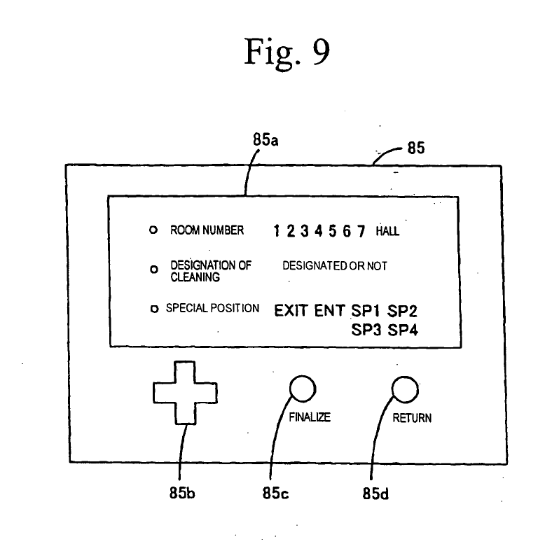

The infrared communication unit 80 includes an infrared communication module 81 which can receive an infrared signal in which position information transmitted from the marker described hereinafter is coded. The above-mentioned position information can be decoded and then transmitted to the CPU 21. FIG. 9 shows the appearance of the above-mentioned marker 85. The marker 85 is provided on the outside thereof with a liquid crystal display panel 85a, a cross key 85b, a finalization key 85c, and a return key 85d. Also, the marker 85 is provided in the interior thereof with a single chip microcomputer, an infrared transmit-receive unit, a battery and the like. The single chip microcomputer produces a setting parameter that corresponds to the operation of the above-mentioned finalization key 85c and the return key 85d, while controlling presentation on the liquid crystal display panel 85a according to the operation of the finalization key 85c and the return key 85d, and can output positioning information corresponding to the setting parameter from the above-mentioned infrared transmit-receive unit.

Matters that can be set in the illustrated embodiment includes room number “1-7 and hall”, cleaning “designated or not”, and special position “EXIT (exit)”, “ENT (entrance)”, “SP1 (special position 1)”, “SP2 (special position 2)”, “SP3 (special position 3)”, and “SP4 (special position 4)”. In an embodiment that will be discussed hereinafter, monitoring an invasion of a suspicious person is performed at the special positions 1-4 where are previously set. A flowchart that is required for the setting is not of a special flowchart is of a flowchart that may be made by those skilled in the art.

The operation of the self-propelled cleaner constructed as discussed above will be described hereinafter.

(1) Regarding the Travel Control and Cleaning Operation:

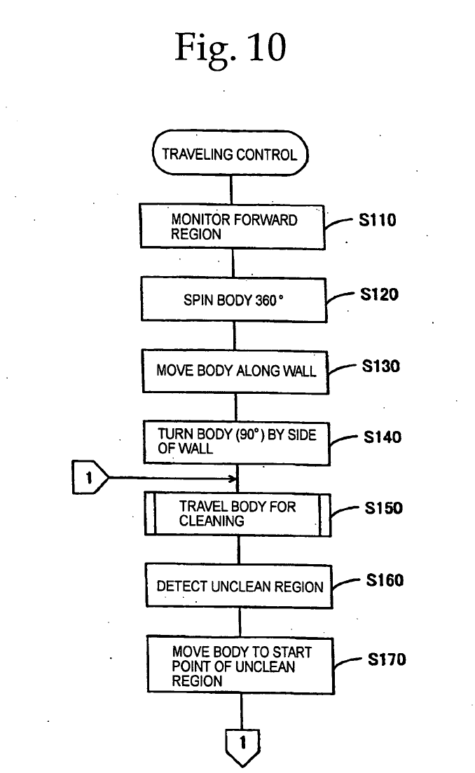

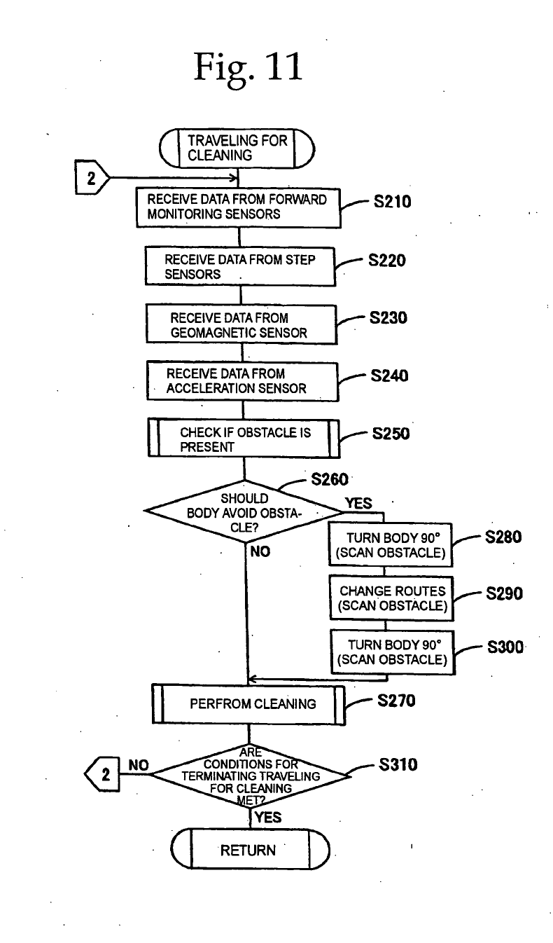

FIGS. 10 and 11 illustrate flowcharts that correspond to a control program that is performed by the above-mentioned CPU 21, and FIG. 2 shows a travel route in which the self-propelled cleaner according to the present invention travels according to the control program.

When the power supply is turned on, the CPU 21 begins performing the travel control shown in FIG. 10. In a step S110, detection results obtained by the AF proximity sensors 31 are inputted and a forward area is monitored. Detection results used for monitoring the forward area are detection results obtained by the AF proximity sensors 31FR, 31FM, 31FL. In the event of a flat floor, what is obtained from an image of the flat floor is the distance L1 to the floor surface in an oblique, downward direction that is shown in FIG. 4. Based on the detection results obtained by the respective AF proximity sensors 31FR, 31FM, 31FL, it is possible to judge whether or not a forward floor surface corresponding in width to the width of the body BD is flat. Incidentally, since information about an area between a floor position which the respective proximity sensors 31FR, 31FM, 31FL face, and a position immediately before the body is not obtained at this time, the area becomes a dead space.

In a step S120, the driving wheel motors 42R, 42L are instructed through the motor drivers 41R, 41L so as to be driven in different directions and in the same rotation amount. This causes the body BD to begin turning on the spot. Rotation amount of the driving motors 42R, 42L that is required for 360° turning (spin turn) on the same spot is previously found and the CPU 21 instructs the motor drivers 41R, 41L to cause the driving wheel motors 42R, 42L to be driven in the same rotation amount.

During the spin turn, the CPU 21 receives the detection results obtained by the AF proximity sensors 31R, 31L and the body BD judges the situation of the location immediately before the body. The above-mentioned dead space becomes a space that is generally viewed by the detection results during this. Where there is not a step and an obstacle, the existent of an environmental flat floor can be detected.

In a step S130, the CPU 21 instructs the motor drivers 41R, 41L to cause the driving wheel motors 42R, 42L to be driven in the same rotation amount. This causes the body BD to begin straight-ahead traveling. During the straight-head traveling, the CPU receives detection results obtained by the AF proximity sensors 31FR, 31FM, 31FL, and the body is advanced while judging whether or not any obstacles exists in the front. When a wall surface that is the obstacle exists in the front can be detected by the detections results, the body is stopped at a front location spaced apart from the wall surface at a predetermined distance.

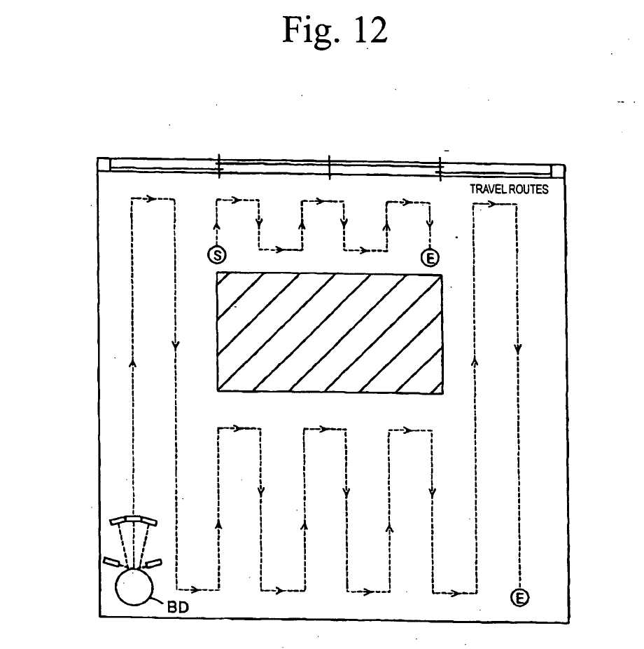

In a step S140, the body is turned at 90° in a right direction. In the step S130, the body is stopped in the front location spaced apart from the wall surface at the predetermined distance. The predetermined distance corresponds to a region in which when the body BD is turned, the body BD does not collide with the wall surface, and corresponds to an outside of the body width that is detected by the AF proximity sensors 31R, 31L for judging the situation of the location immediately before the body and the situation of the left and right sides. That is, when the body is stopped according to the detection results obtained by the AF proximity sensors 31FR, 31FM, 31FL in the step S130 is turned at 90°, the predetermined distance is set to the degree to which at least the AF proximity sensor 31L can detect the position of the wall surface. Furthermore, when the body is to be turned at 90°, the situation of the location immediately before the body is previously judged according to the detection results obtained by the AF proximity sensors 31R, 31L. FIG. 12 shows a situation where the body that arrives at a room (as viewed from the plane) in the manner as described above starts cleaning traveling at a cleaning start location that is a right-lower corner of the room.

As the process of arrival at the cleaning start location, there are various processes besides the above-mentioned process. Where the body is merely turned at 90° in the right direction in a condition where the body may collide with the wall surface, cleaning is carried out at a middle of the first wall surface. Therefore, if the body arrives at an optimum location of the right lower corner, a travel control in which the body is collided with the wall surface, turned at 90° in a left direction, advanced until the body is abutted against the front wall surface, and turned at 180° upon being abutted against the wall surface is a preferable travel control.

In a step S150, cleaning and traveling are carried out. The detailed flowchart for the cleaning and traveling are illustrated in FIG. 11. Upon advancing and traveling, the detection results obtained by the various sensors are inputted in steps S210-S240. In the step S210, the forward monitoring sensor data are inputted. Concretely, the detection results obtained by the AF proximity sensors 31FR, 31FM, 31FL, 31CL are inputted and then used for judging whether any obstacle or a wall surface exists forwardly of the traveling region. Incidentally, in a broad sense, forward monitoring includes monitoring of the ceiling.

In the step S220, step sensor data are inputted. Concretely, the detection results obtained by the AF proximity sensors 31R, 31L are inputted and then used for judging whether or not there a step at a location immediately before the travel region. Furthermore, when the body is moved along the wall surface and any obstacle and parallel to them, distances to the wall surface and obstacle are measured and then used for judging whether or not the body is moved parallel to them.

In the step S230, geomagnetic sensor data are inputted. Concretely, detection results obtained by the geomagnetic sensor 43 are inputted and then used for judging whether or not a travel direction of the body varies during the straight-ahead traveling. For example, an angle of the geomagnetism at the time of the start of cleaning and traveling is previously memorized, and when an angle is detected during the traveling is different from the memorized angle, the rotation amount of the left/right driving wheel motors 42R, 42L is slightly varied, to thereby correct the travel direction, and the angle of the body is returned to its original angle. For example, when the angle of the body varies in such a direction as to increase (change from 359° to 0° is an exception), it is necessary to correct the trajectory in the left direction, and instructions to control the driving so as to slightly increase the rotation amount of the right driving wheel motor 42R as compared with the rotation amount of the left driving wheel motor 42L are outputted to the respective motor drivers 41R, 41L.

In the step S240, acceleration sensor data are inputted. Concretely, the detection results obtained by the acceleration sensor 44 are inputted, and then used for confirming the state of traveling. For example, when acceleration in a substantially fixed direction can be detected at a time of straight-ahead traveling start, it can be judged that normal traveling is performed. By detecting the acceleration of the rotation, such an abnormality in which one of the driving wheel motors is not driven can be judged. Furthermore, when the acceleration exceeds an acceleration value within a normal range, such abnormalities in which the body is dropped from a step or the like and overturns and rolls sideways can be judged. Also, when a large acceleration in such a direction as to be rearward can be detected in advancing, such an abnormality in which the body is collided with a forward obstacle can be judged. In this way, a direct control of the traveling, in which an acceleration value is inputted and a target acceleration value is maintained or a speed is obtained based on the integral value is not performed, but the acceleration value is effectively used for the purpose of detecting any abnormality.

In a step S250, any obstacle is judged based on the detection results that are obtained by the AF proximity sensors 31FR, 31FM, 31CL, 31FL, 31R, 31L and inputted in the steps S210 and S220. The judgment of the obstacle is performed for portions of the front, right-forward, and ceiling. The front is detected as an obstacle or a wall surface. For the location immediately before the body, the situation of the left/right sides out of the traveling range, for example, the presence or absence of a wall surface or the like is detected together with the judgment of a wall surface. The ceiling is used for judging that the body is moved to a hall that is the outside of the room, even if the ceiling is lowered by lintels or the like.

In a step S260, the detection results obtained by the respective sensors are synthetically judged, and a judgment as to whether or not avoidance is necessary is made. Unless the avoidance is necessary, a cleaning process in a step S270 is carried out. The cleaning process is a process in which suction of dirt and/or dust is performed while causing the side brushes and the main brush to be rotated. Concretely, instructions to drive the respective motors 51R, 51L, 52, 55 are outputted to the motor drivers 53R, 53L, 54, 56. Of course, such instructions are always outputted during the traveling and are stopped when conditions for termination of the cleaning and traveling are established as will be discussed hereinafter.

On the other hand, when the avoidance is judged to be necessary, a 90° turn in the right direction is performed. This turn is a 90° turn at the same location. Instructions to cause the driving wheel motors 42R, 42L to be driven by rotation amount, that is required for the 90° turn, while changing rotational directions thereof are given to the driving wheel motors 42R, 42L through the motor drivers 41R, 41L. The rotational direction for the right driving wheel is instructed as a retreat direction and the rotational direction for the left driving wheel is instructed as an advance direction. In rotation, the detection results obtained by the AF proximity sensors 31R, 31L that are step sensors are inputted, and the state of an obstacle is judged. For example, when any obstacle is detected in the front and the 90° turn in the right direction is performed, if the AF proximity sensors 31R do not detect a wall surface at a location immediately before a forward, right direction, abutting of the body against the front wall surface is merely judged. Where the AF proximity sensors 31R detect a wall surface at the location immediately before the forward, right direction, going of the cleaner into the corner portion is judged. Furthermore, where both the AF proximity sensors 31R and 31L do not detect any obstacle at the location immediately before the body, a small obstacle or the like rather than abutting against the wall surface can be judged.

In a step S290, the cleaner is advanced for change of a course while scanning the obstacle. The cleaner is abutted against the wall surface and advanced after it is turned at 90° in the right direction. Where the cleaner is stopped short of the wall surface, an ahead-traveling amount generally corresponds to the width of the body BD. During the above-mentioned movement, the presence or absence of the front obstacle and the forward left/right obstacles is always scanned to thereby confirm the situations thereof that are memorized as information about the presence or absence of the obstacles in the room.

As described above, the 90° turn in the right direction is performed twice. Then, if a 90° turn in the right direction is carried out at the time of detecting any obstacle in the front, the cleaner is returned to its original position. Therefore, the twice 90° turn in the right direction and the twice 90° turn in the left direction are alternately performed in such a manner that the twice 90° turn in the right direction is first repeated, the twice 90° turn in the left direction is then repeated, and thereafter the twice 90° turn in the right direction is repeated. Therefore, for avoidance of the obstacle at an odd time, a right turn is performed, and for avoidance of the obstacle at an even time, a left turn is carried out.

The cleaner scans the interior of the room in a zigzag manner while avoiding the obstacle as described above, and repeats the cleaning and traveling. Then, whether or not the cleaner arrives at the termination of the room is judged in a step S310. The termination of the cleaning and traveling includes a case where after twice turn is performed, the cleaner is advanced along the wall surface and performs the cleaning and traveling, and thereafter any obstacle is detected in the front and a case where the cleaner enters the region which it already traveled. That is, the former is termination conditions that are produced after the cleaner traveling in the zigzag manner travels all the final way, and the latter is termination conditions that are produced at the time of starting re-cleaning and re-traveling after an unclean region is found as will be discussed hereinafter.

If the termination conditions are not established, the cleaner is returned to the step S210 and subjected to the above processes. Where the termination conditions are established, the sub-routine process of the cleaning and traveling is terminated and the cleaner is returned to the process shown in FIG. 10.

After the returning, whether or not an unclean region is left is judged in the step S160 from the travel route which the cleaner has traveled until now, and the environmental situations of the travel route. If the unclean region is found, the cleaner is moved to a start point of the unclean region in a step S170, and returned to the step S150 and starts cleaning and traveling.

Even if unclean regions are interspersed at a plurality of places, by repeating detection of the unclean regions each time such termination conditions as described above are established, the unclean regions are finally cleaned.

(2) Regarding the Mapping:

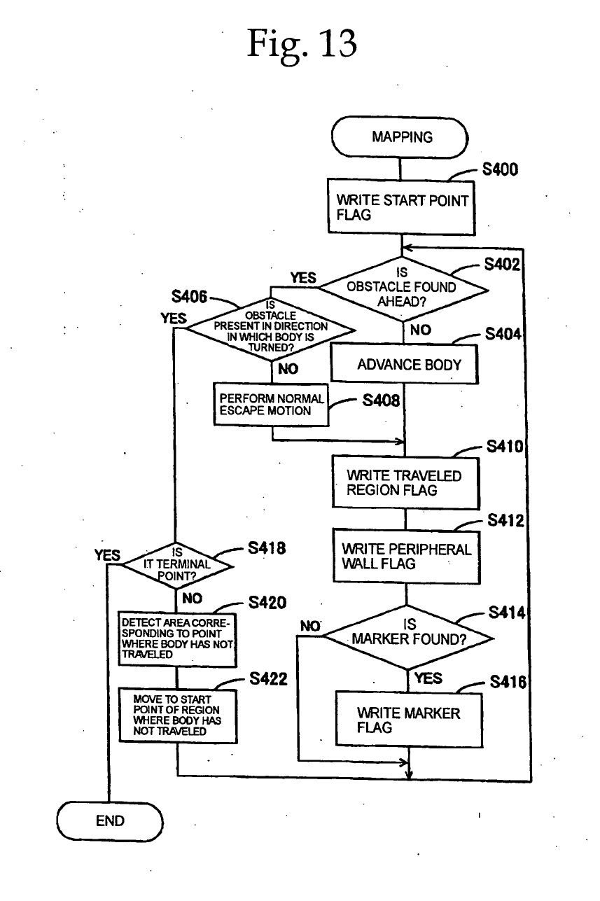

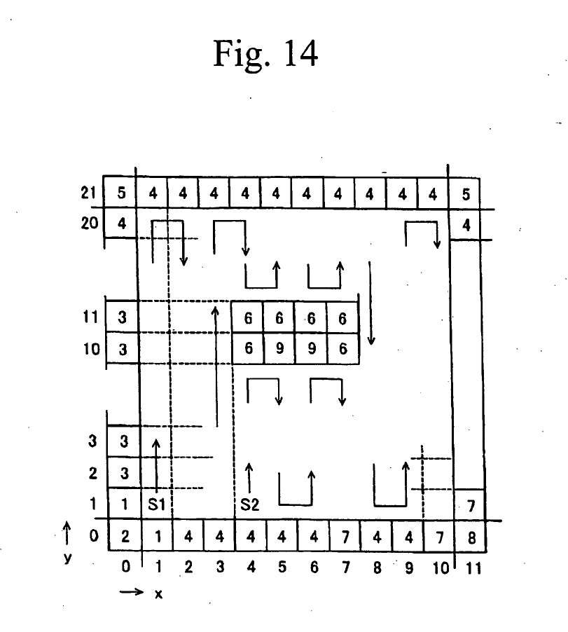

While the judgment of the presence or absence of the unclean regions can be performed using various processes, it is performed in the illustrated example by a mapping process shown in FIGS. 13 and 14.

FIG. 13 is a flowchart for the mapping. FIG. 14 is a view that is of assistance in explaining the mapping process. In this example, the judgment of the presence or absence of the unclean regions is performed by writing the travel route of the room, which the cleaner travels according to the detection results obtained by the above-mentioned rotary encoder, and the presence or absence of the wall surface, that is detected during the traveling, onto a map that is obtained and designated in a memory region, and by judging whether or not the environmental wall surface is continued without being disconnected, and the surroundings around the obstacle present in the room are continued, and the cleaner has traveled all the regions besides the obstacle in the room.

A database for the mapping is a two-dimensional database in which it is possible to address and designate by the x-axis and the y-axis. In the database, (1, 1) is a start point that is the corner portion of the room, and (n, 0), (0, m) designate temporary wall surfaces. As the body BD travels, mapping of the room is performed by separating the size of the body BD as an unit area of 30 cm×30 cm into an unclean region, a cleaned region, a wall surface, and an obstacle.

In a step S400, a start point flag is written. As shown in FIG. 14, the start point (1, 1) is the corner portion of the room. 360° spin turn is performed, confirmation of the presence of the surface wall backward and left is carried out, writing of a wall flag into the respective unit areas is performed, and wiring of a wall flag into the intersection (0, 0) of a wall and a wall is performed (2). In a step S402, whether or not an obstacle exists in front of the body BD is judged, and when an obstacle does not exist in front of the body BD, the body BD is advanced by the unit area in a step S404. Actually, this advance is advance involving the above-mentioned cleaning. Concretely, when the body BD is moved by the unit area from the output of the rotary encoder during moving involving the cleaning, the mapping process is synchronously performed in parallel.

On the other hand, when the presence of an obstacle in front of the body is judged, whether or not an obstacle exists in a turn direction is judged in a step S406. Avoidance of the obstacle shall be performed by 90° turn, advancing, and 90° turn. The direction of turn is successively changed by repeating twice right turn and twice left turn. If turn for next avoidance is the right direction and an obstacle exists in front of the body, whether or not the body can advance in the right direction and turn is judged. The right direction is at first an unclean region. Judgment is performed as the absence of an obstacle in the right direction, and normal escape motion is performed in a step S408.

After these movements, a travel region flag is written into the unit area of the travel route in a step S410. Since the traveling means that cleaning is performed, a flag indicative of a cleaning finished area is written. In a step S412, the situation of an environmental wall surface is written. When the body is moved from a unit area (1, 1) to a unit area (1, 2), it is possible to judge whether or not unit areas (0, 1), (2, 1) are walls, on the basis of the detection results by the AF proximity sensors. Regarding the unit area (0, 1), it is possible to write a flag indicative of a wall. Regarding the unit area (2, 1), it is possible to write a flag indicative of the absence of a wall, a unclean region and a region where the body has not traveled.

On the other hand, in a unit area (1, 20), an obstacle is detected ahead and the body performs 180° turn of an advance direction while performing 90° turn two times. At this time, it is possible to write (4) flags for respective unit areas (0, 20), (2, 20), (1, 21), (2, 21). Furthermore, regarding a unit area (0, 21), a flag indicative of a wall is written (5) on the basis of judgment that it is an intersection of a wall and a wall. Incidentally, regions where the body has traveled and has cleaned are processed as obstacles.

When the body is advanced, an obstacle is detected in the right direction, and a flag indicative of an obstacle is then written (6). Incidentally, when the body is moved in unit areas (3, 1)-(3, 9), an unclean region is detected in the right direction relative to the advance direction, a flag indicative of an unclean region is written. Similarly, when the body is moved in unit areas (8, 9)-(8, 1) later, a region where the body has not traveled and has not cleaned is detected in the right direction relative to the advance direction, a flag indicative of the matter is written.

Furthermore, in a unit area (4, 12), the obstacle is detected ahead and escape motion is performed. At this time, since regarding the unit area (4, 11), the flag indicative of an obstacle is written, the flag indicative of an obstacle is written for the unit area (4, 11) as the body is moved.

In a step S414, whether or not position information communication with the above-mentioned marker 85 has been performed in the unit areas where the body has traveled is judged. When the communication with the marker has been performed, a flag is written on the basis of information obtained from the marker. For example, if the user designates a specific unit area by operating the operation keys 85b-85d of the marker 85 in order to designate an escape exit, when the body BD passes the same unit area, the infrared communication unit 80 obtains the position information, so that a flag indicative of an escape exit is written for the unit area.

Advance and escape motion is repeated, and in a unit area (10, 20), an obstacle is found in the left direction relative to the advance direction. In this case, since the unit area (10, 20) is judged as a continued wall, a flag indicative of a wall is written (4) for the unit area (11, 20) and a flag indicative of a wall is then written (5) for an intersection (11, 21).

As a result of the repeated advance and escape motion, in a unit area (10, 1), an obstacle is found ahead and it is judged that an obstacle is also present in the turn direction. Therefore, in this case, termination or no is judged in a step S418. Incidentally, for the unit area (10, 1), a forward obstacle and an obstacle in the left direction relative to the advance direction are found (7), (8).

Whether or there is a unit area in which a flag indicative of a region where the body has not traveled and cleaned is written is the first judgment item for terminal or no. Where the unit area in which the flag indicative of the region where the body has not traveled and cleaned is written is not found, whether or not wall indicating flags that are written at the start point continuously go around is judged. If the flags go around, the room is scanned in the X-direction and Y-direction, thereby to search a region in which a flag is written. Incidentally, regarding the regions which are judged to be obstacles, the regions are judged as a continued region like walls. In this way, the detection of obstacle is finished.

In a case being not termination, a region where the body have not traveled is detected in a step S420, in a step S422 the body is moved to a start point of a region where the body has not traveled, and the above-mentioned processes are then repeated. If termination is finally judged, the mapping process is completed. On the completion of the mapping process, the walls and travel areas in the room have become obvious, and are then used as map data of respective rooms.

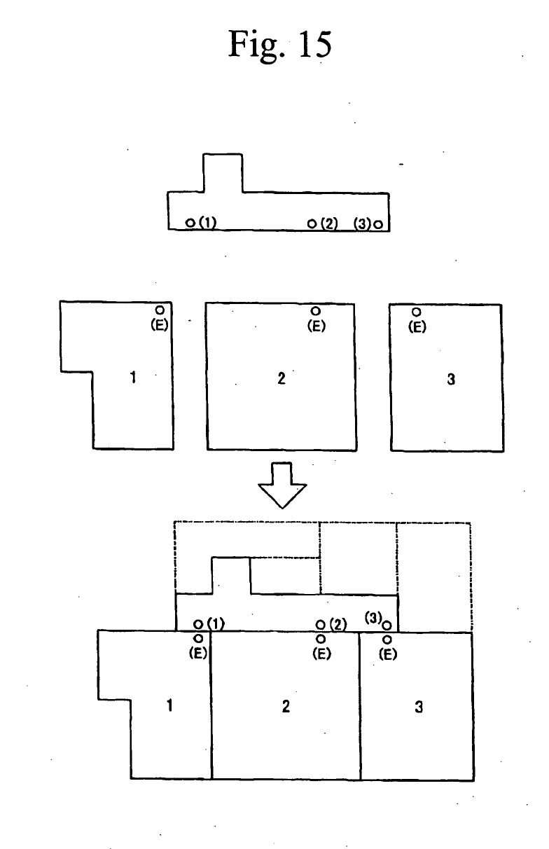

For all rooms and halls, the above-mentioned mapping process is completed, and entrances to the respective rooms are designated by the marker 85 for the halls. FIG. 15 illustrates a process for performing communication of the map data of the respective rooms and halls. For all rooms and halls, room number (1-3) and entrances (E) of the respective rooms, and entrances (1-3) to the room from the halls, or the like are designated, whereby map data obtained for every rooms can be planar-connected

(3) Regarding Watch Mode:

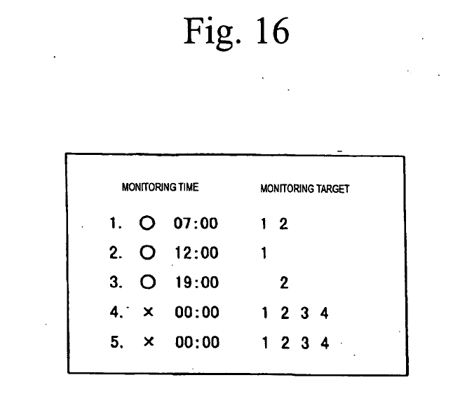

FIG. 16 illustrates a setting screen for watch time and watch place.

By operating the operation switch 15a and the liquid crystal display panel 15b, watch places to which the cleaner goes on watching and time for watching a suspicious person are designated. Time for patrol can be set by 5 times and locations of the watch places can be set by four locations according to special places SP1-SP4 of the marker 85. References “O” and “X” given before time in FIG. 16 respectively indicate that patrol should be performed or should not be performed at respective time. In the example shown in FIG. 16, it is set in such a manner that the cleaner goes to a 1st-watch place and a 2nd-watch place at 7:00 o'clock, goes to the 1st-watch place at 12:00 o'clock, and goes to the 2nd-watch place at 19:00 o'clock. Incidentally, this is not to say that in connection with setting of patrol time, a clock mechanism is provided.

A program for setting of time and designation of patrol and watch place is processed according to a flowchart that is realized by those skilled in the art with his (or her) ordinary ability.

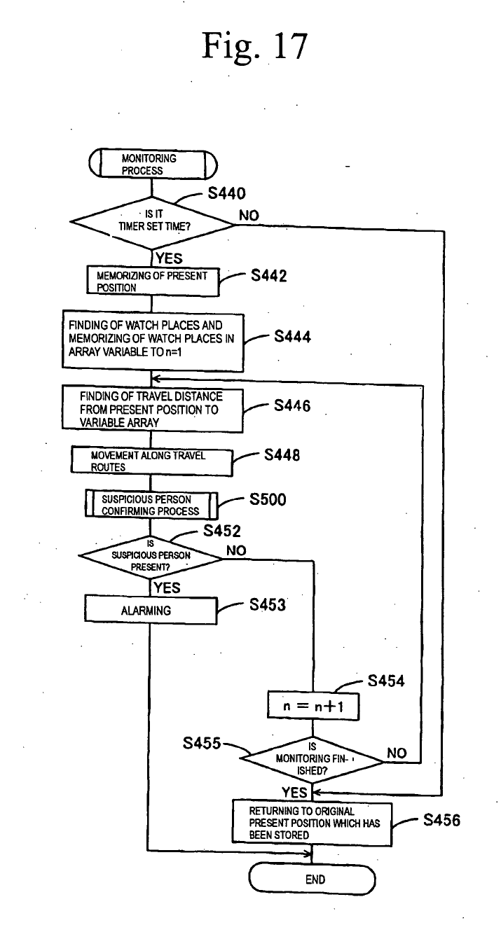

FIG. 17 shows a watch process flow. When the operation panel unit 15 sends instructions to perform this process, comparison between the present time and a set time of a timer is made, whereby whether or not the present time is the timer setting time is judged. If the present time is the timer setting time, the following process is performed.

In a step S442, the present position is stored. By storing the present position at this time, it is possible to return to the present position after the cleaner goes to a final watch place.

In a step S444, a watch place to be subjected to patrol is obtained and is stored in an arrangement variable. If the present time is 7:00 o'clock, the watch places to be subjected to patrol are the 1st-watch place and the 2nd-watch place. Therefore, the location of the 2nd-watch place is obtained and then stored in the arrangement variable. By storing in the arrangement variable, it is possible to successively patrol according to a variable n. Therefore, “1” is set to the variable n.

In a step S446, a travel route from the present position to an nth-watch place stored in the arrangement variable is obtained.

In the case where the cleaner comes complete with the map data as discussed above, it is possible to search a travel route from the present position to the position of the nth-watch place. In order to obtain the travel route, known process for answer to a maze can be employed. For example, if advance is performed along a advance direction while always touching a wall by the right hand according to a right-hand process or so, it is possible to arrive at a goal from an entrance at any rate. Thereafter, prolix routes are successively deleted. For example, places where returning is performed after 180° turn is carried out are successively deleted. Because of the interior of a room, search for U-turned portions are performed, and unless there is not an obstacle, the route is shortened while causing the turned portion to be this side. It is a matter of course that in lieu of the case where the travel routes are automatically found in this manner, an interface for indicating travel routes to the user may be provided.

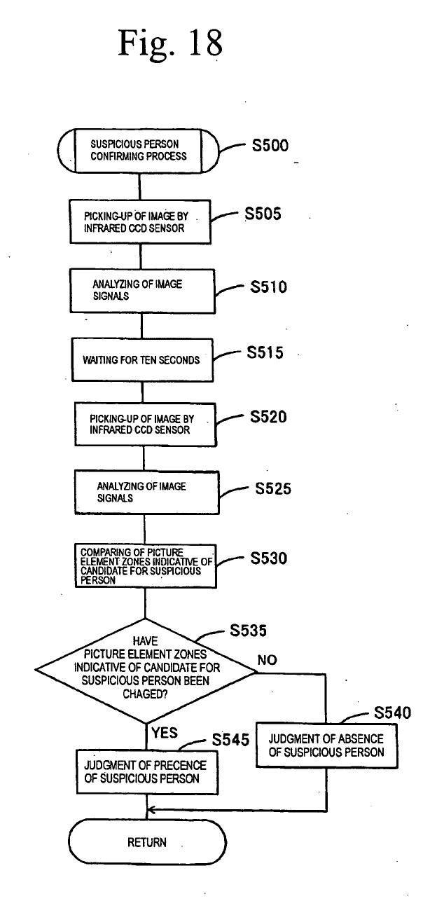

After the travel routes from the present position to the location of the watch places are found, movement along the travel routes is performed in a step S448. After the movement is completed, confirming process of a suspicious person is performed in a step S500 in a state where driving and steering is stopped. FIG. 18 illustrates a suspicious person confirming process. Incidentally, monitoring programs for performing the processes of FIGS. 17, 18 by the CPU 21 or the like are memorized in the ROM 23, and the processes are performed by suitably retrieving the monitoring programs. In the process shown in the same Figure, image picking-up is carried out by the infrared CCD sensor 73 and the above-mentioned image signals are outputted to the CPU 21.

The image signals outputted to the CPU 21 are temporarily memorized in the RAM 22. In a step S510, the image signals temporarily memorized in the RAM 22 are analyzed, whereby a candidate for a suspicious person is detected. For example, a value range of light quantity of infrared rays emitted from the human is previously set according to measurement or the like, and picture elements within the value range are specified. If the specified picture elements are continuously distributed over a picture element zone concentrated to some degree, the picture element zone is memorized in the RAM 22 as a candidate for an image of a suspicious person. If there is not a picture element zone corresponding to a candidate for an image of a suspicious person, the matter is memorized in the RAM 22. For example, if picture elements within the value range are continued only by a few picture elements, the picture element zone is excluded from a candidate for an image of a suspicious person, whereby definite noises can be eliminated.

In a step S515, the cleaner waits for ten seconds without steering and driving. After ten seconds has passed, the infrared CCD sensor 73 again picks up an image in a step S515. That is, picking up an image of the same view is performed in the step S505 and a step S520 at different time. Image signals obtained in the step are also sent to the CPU 21. Then, in a step S525, a process is performed in the same manner as performed in the step S510, and a picture element zone that corresponds to a candidate for an image of a suspicious person is specified. In a step S530, comparison between the picture element zone corresponding to the candidate for the image of the suspicious person that has been specified in the step S510, and the picture element zone corresponding to the candidate for the image of the suspicious person that has been specified in the step S525, is made and whether or not there is a change between them is judged in a step S535.

Where there is change between them, it is judged in a step 545 that a suspicious person is present. Where there is no change between, it is judged that a suspicious person is absent. That is, whether or not there is a change in a candidate for an image of a suspicious person can be judged by specifying a picture element zone corresponding to a candidate for an image of the suspicious person at several time and deciding the presence or absence of change in the picture element zones. If there is a change in a candidate for an image of a suspicious person, it is highly possible that the candidate for the image of the suspicious person is the human. Therefore, when there is a change in a candidate for an image of a suspicious person, it shall be judged that a suspicious person is present. Based on the change, there is no possibility that, for example, infrared light intermittently incident from a window is judged as a suspicious person.

Incidentally, in a case where a picture element zone that corresponds to a candidate for an image of a suspicious person appears on picking-up of an image in the step S520 although there is no picture element zone corresponding to a candidate for an image of a suspicious person upon picking-up of an image in the step S505, it is possible to judge that a suspicious person is present. On the other hand, in a case where although a picture element zone that corresponds to a candidate for an image of a suspicious person appeared upon picking-up of an image in the step S505, the picture element zone that corresponds to a candidate for an image of a suspicious person disappears upon picking-up of an image in the step S520, it is possible to judge that a suspicious person was present. In either case, it is possible to regard the case as a change in a picture element zone corresponding to a candidate for an image of a suspicious person. Furthermore, the presence or absence of a suspicious person can be judged using a change in the quantity of light in lieu of a change in a picture element zone corresponding to a candidate for an image of a suspicious person.

When either judgment is performed in a step S545 or a step S540, a step S452 shown in FIG. 17 is performed. When the presence of a suspicious person is judged in the step S545, alarms are produced in a step S453. Concretely, the CPU 21 sends a predetermined signal to the speech circuit 29a through the bus 24, and the speech circuit 29a produces speech signals based on the predetermined signal. The speech signals are then outputted by the speaker 29b. By the alarms, it is possible to inform the user or other person beside the cleaner, of the presence of a suspicious person, and it is also possible to give a warning to the suspicious person.

Furthermore, in a step S453, it is also possible to perform the transmit-receive of mail through the internet by the wireless LAN module 61. For example, where the user has a portable mail-receiver terminal, it is possible to call the user's attention by transmitting an alarm mail to the terminal.

On the other hand, when a suspicious person is confirmed, the variable n is increased in a step S454 and whether or not patrol is finished is judged according to a value of the variable in a step S455. That is, if the value of the variable is increased as compared to the number of the watch places that is obtained in the step S444, the patrol is finished, and returning to the original present position stored in the step S442 is performed. On the other hand, in the event that the patrol is not finished, returning to the step S446 is carried out. Then, a travel route from the present position at this time to the location of a next watch target is found.

As discussed above, the electronic components with which the monitoring unit 70 is provided are the infrared CCD sensor 73 and the output connector 72 only, so that the monitoring unit 70 is simple in construction. That is, the monitoring unit 70 is designed such that it is not provided with a substrate or electronic parts having complex wirings and contacts, whenever possible. Therefore, even if excessive force is applied to the monitoring unit 70 upon installation of the monitoring unit 70, it is possible to prevent producing of disorders of the monitoring unit 70. Furthermore, even if dirt and/or dust enters the recessed portion B1, possibilities that the dirt and/or dust will produce electrical short and disorders of the monitoring unit will occur can be reduced. If needed, the user can attach the monitoring unit 70 to the body BD. The infrared CCD sensor is not provided at the body BD, so that the cost of the body BD itself can be decreased.

Incidentally, the body BD is provided with the CPU 21, the RAM 22 and the ROM 23, so that when the infrared CCD sensor 73 is attached to the body BD, it is possible to performing a monitoring process utilizing the infrared CCD sensor 73. That is, if a program for performing a monitoring process is previously memorized in the ROM 23 or the like, it is possible to watch a suspicious person without addition of hardware, especially. Therefore, a production cost of the body BD is not increased. Furthermore, the program for performing the monitoring process is not limited to such a program as previously memorized in the ROM 23 or the like, and may be such a program as memorized in a storage medium of the body BD upon the purchase of the body BD. Also, a program may be downloaded from a website using the wireless LAN module 61. In this case, the body BD may be provided with EEPROM or the like that is a rewritable storage medium.

These and other advantages of the present invention will be apparent to those skilled in the art from the foregoing specification. Accordingly, it will be recognized by those skilled in the art that changes or modifications may be made to the above-described embodiments without departing from the broad inventive concepts of the invention. It should therefore be understood that this invention is not limited to the particular embodiments described herein, but is intended to include all changes and modification that are within the scope and sprit of the invention as set forth in the claims.

What is claimed is:

1. A self-propelled cleaner comprising:
a body provided with a cleaner mechanism; and
a driving mechanism for realizing steering and driving;
said body comprising:
a recessed portion to which a monitoring unit can be mounted;
said monitoring unit comprising at least an infrared CCD sensor, an output connector that can output image signals obtained by said infrared CCD sensor, and a positioning plate of a substantially plate-shape;
a positioning hole into which said positioning plate inserted, whereby said monitoring unit is positioned;
an input connector electrically connected to said output connector through said recessed portion;
an infrared ray-permeable lid portion for covering said monitoring unit mounted to said recessed portion;
an image analyzing unit for analyzing said image signals inputted from said input connector, to thereby judge whether or not an image of a suspicious person is picked up by the infrared CCD sensor;
a speaker;
a wireless LAN; and
a warning unit for alarming through said speaker when said image analyzing unit judges that said image of said suspicious person is picked up by said infrared CCD sensor, and transmitting alarm signals to other devices through said wireless LAN.

2. A self-propelled cleaner comprising:
a body provided with a cleaner mechanism; and
a driving mechanism for realizing steering and driving;
said body comprising:
a recessed portion to which a monitoring unit can be mounted;
said monitoring unit comprising at least an image picking-up sensor,
and an output connector that can output image signals obtained by said image picking-up sensor;
an input connector electrically connected to said output connector through said recessed portion;
an image analyzing unit for analyzing said image signals inputted from said input connector, to thereby judge whether or not an image of a suspicious person is picked up by said image picking-up sensor; and
a warning unit for alarming when said image analyzing unit judges that said image of said suspicious person is picked up by said image picking-up sensor.

3. A self-propelled cleaner according to claim 2, wherein said monitoring unit is provided with a positioning plate of a substantially plate-shape projecting therefrom, and said recessed portion is formed with a positioning hole in which said positioning plate is inserted, whereby said monitoring unit is positioned.

4. A self-propelled cleaner according to claim 2, wherein said body is adapted to allow a light having a wavelength zone that can be inputted by said image picking-up sensor, to pass through said body, and said body further includes a lid portion for covering said monitoring unit mounted to said recessed portion.

5. A self-propelled cleaner according to claim 2, wherein said image picking-up unit comprises an infrared CCD sensor.

6. A self-propelled cleaner according to claim 2, wherein said body is provided with a speaker and said warning unit is adapted to alarm through said speaker.

7. A self-propelled cleaner according to claim 2, wherein said body is provided with a wireless LAN and said warning unit is adapted to transmit alarm signals to other devices through said wireless LAN.

8. A self-propelled cleaner according to claim 2, wherein said body is of a thin, substantially cylindrical shape, and said recessed portion formed from a top surface of a region corresponding to a front of said body to side surfaces of said region.

9. A self-propelled cleaner according to claim 3, wherein said recessed portion comprises a bottom wall, an innermost wall, and both side walls, said recessed portion being opened at a top and a front thereof, and said positioning hole is formed in a lowermost region of said innermost wall so as to be oriented horizontally and extend linearly, said positioning hole communicating with an interior and an exterior of said body.

10. A self-propelled cleaner according to claim 9, wherein said input connector is disposed at a region of said body above said positioning hole and oriented horizontally, said input connector being electrically connected to said interior of said body.

11. A self-propelled cleaner according to claim 4, wherein said body is of a thin, substantially cylindrical shape, said recessed portion is formed from a top surface of a region corresponding to a front of said body to side surfaces of said region and comprises a bottom wall, an innermost wall, and both side walls, said recessed portion being opened at a top and a front thereof, and said body includes a hinge provided at a uppermost region of said innermost wall and a lid portion pivotally connected to said body through said hinge, said lid portion being formed into an L-shape in cross-section that can cover said opened top and front of said recessed portion.

12. A self-propelled cleaner according to claim 9, wherein said monitoring unit includes an infrared CCD sensor, a substantially plate-shaped base surface and a slant surface, said base surface and said slant surface crossing each other at a predetermined angle, said infrared CCD sensor mounted on a substantially central portion of said slant surface, and a tilt angle of said slant surface being determined so as to allow a view angle of said infrared CCD sensor to optimize for picking up said image of said suspicious person.

13. A self-propelled cleaner according to claim 12, wherein said monitoring unit includes only said infrared CCD sensor and said output connector as electronic parts, whereby said monitoring unit is simple in construction.

14. A self-propelled cleaner according to claim 13, wherein said base surface is formed into a substantially plate-shape, and said positioning plate is formed into a substantially plate-shape having a width slightly smaller than that of said base surface and a thickness slightly smaller than a height of said positioning hole.
